(19) United States
(12) Patent Application Publication
(10) Pub. No.: US 2022/0350499 A1
(43) Pub. Date: Nov. 3, 2022

(54) COLLABORATED PAGE FAULT HANDLING

(71) Applicant: Intel Corporation, Santa Clara, CA (US)

(72) Inventors: Shaopeng HE, Shanghai (CN); Yadong LI, Portland, OR (US); Anjali Singhai JAIN, Portland, OR (US); Kenneth G. KEELS, Austin, TX (US); Andrzej SAWULA, Gdansk (PL); Kun TIAN, Shanghai (CN); Ashok RAJ, Portland, OR (US); Rupin H. VAKHARWALA, Hillsboro, OR (US); Rajesh M. SANKARAN, Portland, OR (US); Saurabh GAYEN, Portland, OR (US); Baolu LU, Shanghai (CN); Yan ZHAO, Shanghai (CN)

(21) Appl. No.: 17/745,453

(22) Filed: May 16, 2022

(30) Foreign Application Priority Data
Mar. 30, 2022 (CN) PCT/CN2022/083959

(51) Int. Cl. G06F 3/06; G06F 9/455

(52) U.S. Cl. CPC G06F 3/0619; G06F 9/45558; G06F 3/0644; G06F 3/0679; G06F 2009/45583

(57) ABSTRACT

As described herein, for a selected process identifier and virtual address, a page fault arising from multiple sources can be solved by a one-time operation. The selected process identifier can include a virtual function (VF) identifier or process address space identifier (PASID). In some examples, solving a page fault arising from multiple sources by a one-time operation comprises invoking a page fault handler to determine an address translation.

### RELATED APPLICATION

This application claims the benefit of priority to Patent Cooperation Treaty (PCT) Application No. PCT/CN2022/083959, filed Mar. 30, 2022. The entire content of that application is incorporated by reference.

### BACKGROUND

In cloud services, applications execute in a virtual environment. Cloud service providers (CSP) leverage hardware virtualization technologies to share hardware resources with virtual environments. Shared hardware resources can include processors, network interface devices, and memory devices. For accesses to a memory device (e.g., reads or writes), translation of virtual-to-physical addresses is performed to identify a target memory region in a memory device. A page fault occurs when a program accesses a page that is mapped to a virtual address, but a corresponding physical memory is not available. Cloud computing scales to multitudes of nodes connected as a cloud system, and other nodes in a cloud system may attempt to solve page faults by providing translations of virtual addresses to physical addresses.

### BRIEF DESCRIPTION OF THE DRAWINGS

FIG. 1 depicts an example system.

FIG. 2 depicts an example sequence.

FIG. 3A depicts an example system.

FIG. 3B depicts an example system.

FIG. 4 depicts an example sequence.

FIG. 5 depicts an example of a page fault entry table.

FIG. 6 depicts an example process.

FIG. 7 depicts an example computing system.

### DETAILED DESCRIPTION

Chapter 10 of Peripheral Component Interconnect Express (PCIe) specification v5.0 (2019) defines a distributed translation system, where devices utilize an Address Translation Cache (ATC) to store virtual to physical address translations. The PCIe specification defines an Address Translation Service (ATS) protocol for ATC to synchronize the ATC with a central translation database of a Trusted Authority (TA). ATS is a PCIe-defined feature to translate a virtual address to a physical address before the device accesses host memory with virtual addresses. An Address Translation Cache (ATC) driver executed by a host can cause a copy of contents from the intermediate buffer to pages subject to page faults. The ATC driver can address a page fault to associate a physical address with a virtual address.

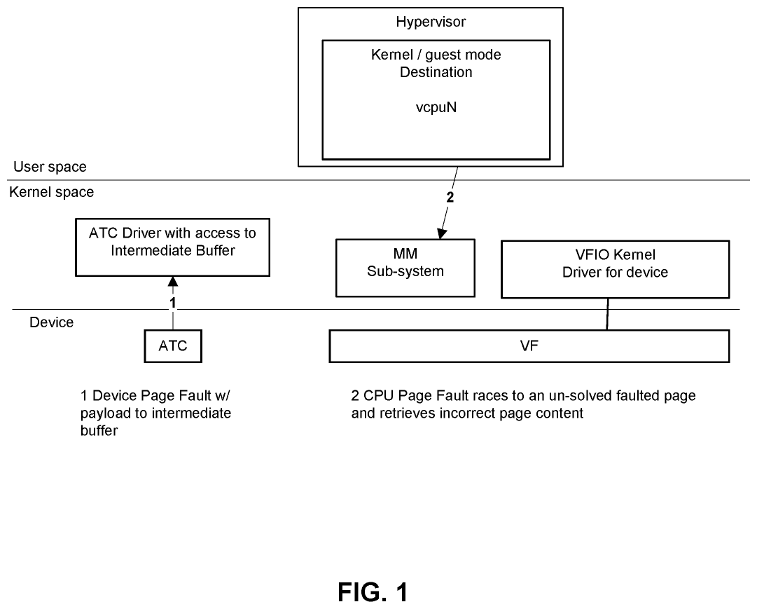

FIG. 1 depicts an example system. For example, in Cloud Service Provider (CSP) environments, devices are assigned directly to a VM and those devices can read or write data directly to VM memory. The device can include one or more of a network interface device, accelerator, storage device, memory device (e.g., memory pool with dual inline memory modules (DIMMs)), graphics processing unit, audio or sound processing device, and so forth. In some examples, a host system and a device can communicate by use of single-root I/O virtualization (SR-IOV) with the device represented as a virtual function (VF). PCI-SIG Single Root IO Virtualization and Sharing Specification v1.1 and predecessor and successor versions describe use of a single PCIe physical device under a single root port to appear as multiple separate physical devices to a hypervisor or guest operating system. SR-IOV uses physical functions (PFs) and virtual functions (VFs) to manage global functions for the SR-IOV devices. PFs can be PCIe functions that can configure and manage the SR-IOV functionality. For example, a PF can configure or control a PCIe device, and the PF has ability to move data in and out of the PCIe device. In other examples, Intel® Scalable I/O Virtualization (SIOV) can be used to permit configuration of a device to group its resources into multiple isolated Assignable Device Interfaces (ADIs). An example technical specification for SIOV is Intel® Scalable I/O Virtualization Technical Specification, revision 1.0, June 2018, as well as earlier versions, later versions, and variations thereof.

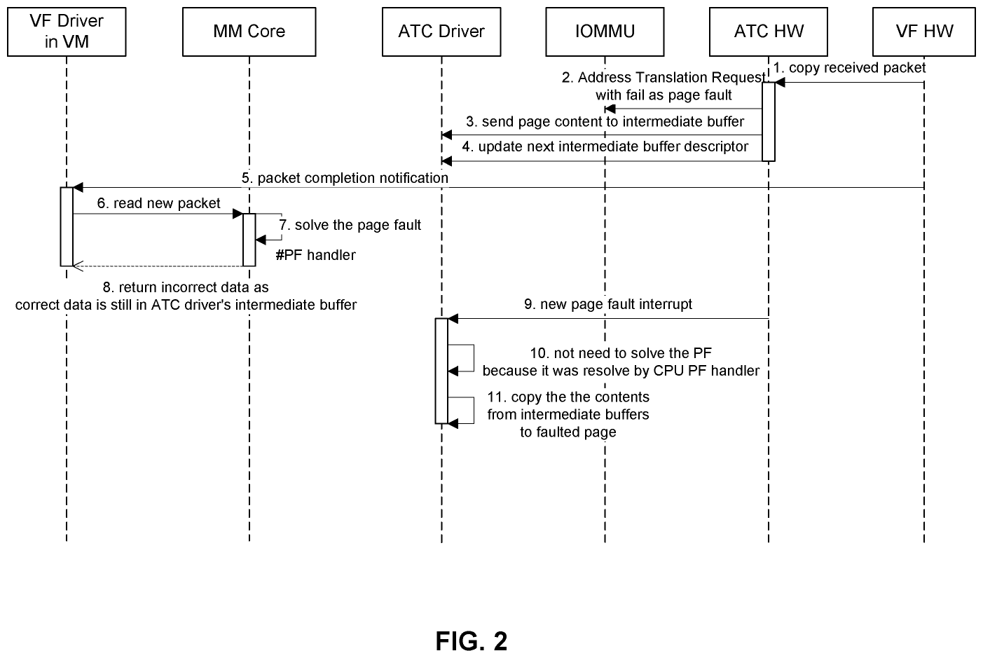

Description next turns to an example operation of the system of FIG. 1. A hypervisor (e.g., QEMU) can pin VM memory to physical memory and configure a host input output memory management unit (IOMMU) (e.g., MM sub-system). At 1, a Device Page Fault occurs and a payload is copied to an intermediate buffer associated with an ATC. However, at 2, a CPU Page Fault races to an un-solved faulted page and retrieves incorrect page content as the page content is stored in the intermediate buffer. Additional description of the page fault race condition is described with respect to FIG. 2.

FIG. 2 depicts an example sequence diagram of a race condition whereby data from a destination page is incorrect data as the data is stored in an intermediate buffer. At 1, a received packet or data associated with a VF for a device is available for processing. The received packet can be copied to a memory associated with a host virtual address associated with target buffers previously provided by a VF driver. At 2, ATC in device determines a virtual address to physical translation is not available and a page fault occurs. ATC requests the IOMMU to provide virtual to physical address translation. IOMMU does not identify a virtual to physical address translation and indicates to ATC there is no translation.

At 3, ATC causes a copy of received packet to an intermediate buffer. At 4, the ATC provides ATC driver (executing on host processor) with an updated network intermediate buffer descriptor to identify an intermediate buffer used to store the received packet. The ATC driver can include a device driver that provides an IOMMU interface to manage the ATC for devices. ATC driver can interface with an MMU sub-system to perform collaborated page fault handling to address race conditions for one or more virtual functions.

At 5, VF provides a packet completion notification, to VF driver, that a packet was received for the device. The VF driver for the device receives a packet completion notification before a page fault. At 6, the VF driver reads a packet from a page identified by the buffer identified in the packet completion notification. However, at 7, the memory management system (MM core) calls a page fault (PF) handler to provide a physical address translation for a virtual memory address because a page associated with a virtual memory address translation does not exist when the VF driver reads the received packet. MM core can include a memory subsystem that writes the virtual memory address to physical address translation into a page table. In some examples, MM core includes a memory controller and the memory controller can manage page faults arising from accesses to a memory device or memory pool.

At 8, data made available to the VF driver is not the received packet identified in (5) as the received packet is stored in the intermediate buffer. At 9, ATC issues a page fault interrupt to ATC driver to provide a virtual to physical memory address translation. At 10, ATC driver invokes PF handler but PF handler solved the page fault in (7). At 11, data is copied from the intermediate buffer to destination page that is associated with translation made at (7).

At least to address the race situation, a collaborated page fault handing design is described herein. For page faults arising from data flow from a device to a host system, an intermediate overflow buffer can provide a buffer for Virtual Functions (e.g., local area network (LAN), Non-volatile memory express (NVMe), remote direct memory access (RDMA), or others etc.) associated with the device. A page fault collaboration framework can be applied for a heterogeneous computing environment to manage access to a page fault intermediate buffer. A MM sub-system provides an application program interface (API) for a driver to register callbacks in kernel space for page fault events of certain memory regions. When a CPU receives a page fault notification in a particular region of a memory, MM's fault handler can call a callback API to coordinate with a related computing partner, e.g., device driver and hardware, to collaboratively solve a page fault merely one time. Multiple sources of page faults can collaborate so that one source handles the page fault. For example, the device driver can collaborate with MM sub-system so that a page fault are handled merely once. Accordingly, a race condition between CPU page fault handling threads and device page fault handling threads can be addressed.

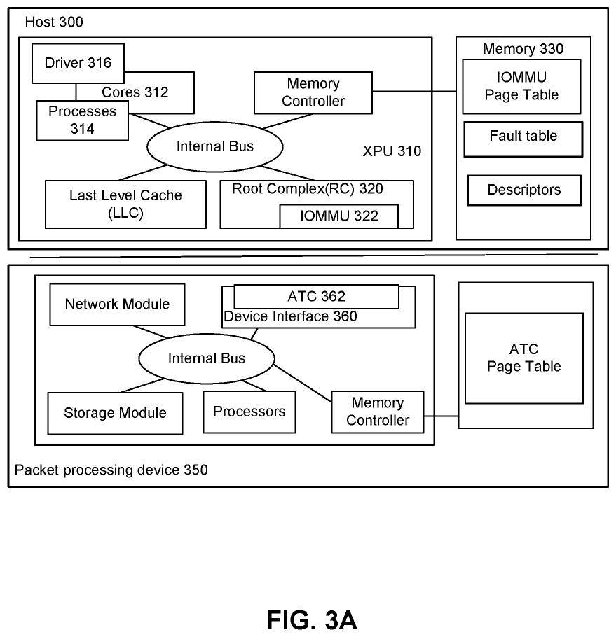

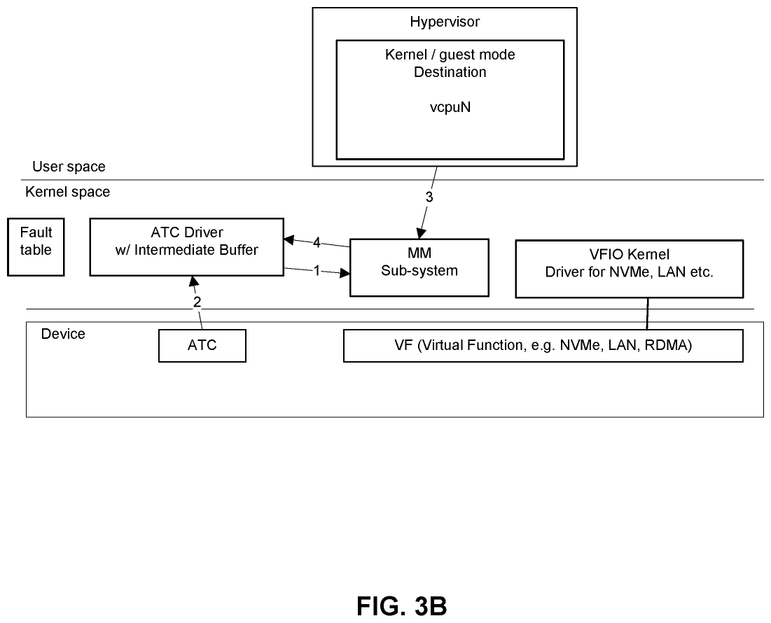

FIG. 3A depicts an example system. Host 300 can include circuitry that can execute one or more processes that transmit or receive packets using packet processing device 350. However, other devices can be used. One or more cores 312 of XPU 310 can execute one or more processes 314. Reference to process 314, virtual machine (VM), application, container, microservice, thread, or function can refer to another one or more of: a process, VM, application, container, microservice, thread, or function. Processes 314 may utilize Direct Memory Access (DMA) copy operations with address translation prefetch to improve the performance of DMA operations by removing or reducing ATS request/response latency.

IOMMU software (e.g., operating system (OS) IOMMU subsystem) and IOMMU 322 can translate virtual address to physical addresses for process 314. Process 314 can request that a translation of a virtual to physical address be provided to packet processing device 350. A virtual address can include a memory mapped virtual address or I/O virtual address. Packet processing device 350 can store the translation in an address translation cache (ATC) 362. As described herein, a device driver 316 (e.g., ATC driver) executed by cores 312 can collaborate with IOMMU 322 to handle page faults.

Memory 330 can store one or more of: an IOMMU page table, fault table, descriptors, or data in one or more buffers. In some examples, memory 330 can be implemented as a memory device or a memory pool. A memory pool can be accessible using a network interface device using protocols such as remote direct memory access (RDMA) or Non-volatile memory express (NVMe) over Fabrics (NVMe-oF) (e.g., NVMe-oF specification, version 1.0 (2016) as well as variations, extensions, and derivatives thereof), among others.

A memory pool can include one or more dual in-line memory modules (DIMMs), or other volatile or non-volatile memory devices. At least two levels of memory (alternatively referred to herein as “2LM” or tiered memory) can be used that includes cached subsets of system disk level storage (in addition to, for example, run-time data). This main memory includes a first level (alternatively referred to herein as “near memory”) including smaller faster memory made of, for example, dynamic random access memory (DRAM) or other volatile memory; and a second level (alternatively referred to herein as “far memory”) which includes larger and slower (with respect to the near memory) volatile memory (e.g., DRAM) or nonvolatile memory storage (e.g., flash memory or byte addressable non-volatile memory (e.g., Intel Optane®)). The far memory is presented as “main memory” to the host operating system (OS), while the near memory is a cache for the far memory that is transparent to the OS, thus rendering the embodiments described below to appear the same as prior art main memory solutions. The management of the two-level memory may be performed by a combination of circuitry and modules executed via the host central processing unit (CPU). Near memory may be coupled to the host system CPU via high bandwidth, low latency means for efficient processing. Far memory may be coupled to the CPU via low bandwidth, high latency means (as compared to that of the near memory). In some examples, a memory controller can manage page faults arising from accesses to a memory device or memory pool, as described herein.

FIG. 3B depicts an example operation. At 1, an ATC driver can register with a memory management system as page fault collaborative. At 2, based on a page fault in an ATC of a device, the data can be stored into an intermediate buffer associated with the ATC driver. At 3, the CPU page fault is issued to the memory management system and the page fault is solved by a page fault handler invoked by the ATC driver. At 4, after resolution of the page fault, the data can be retrieved from the intermediate buffer.

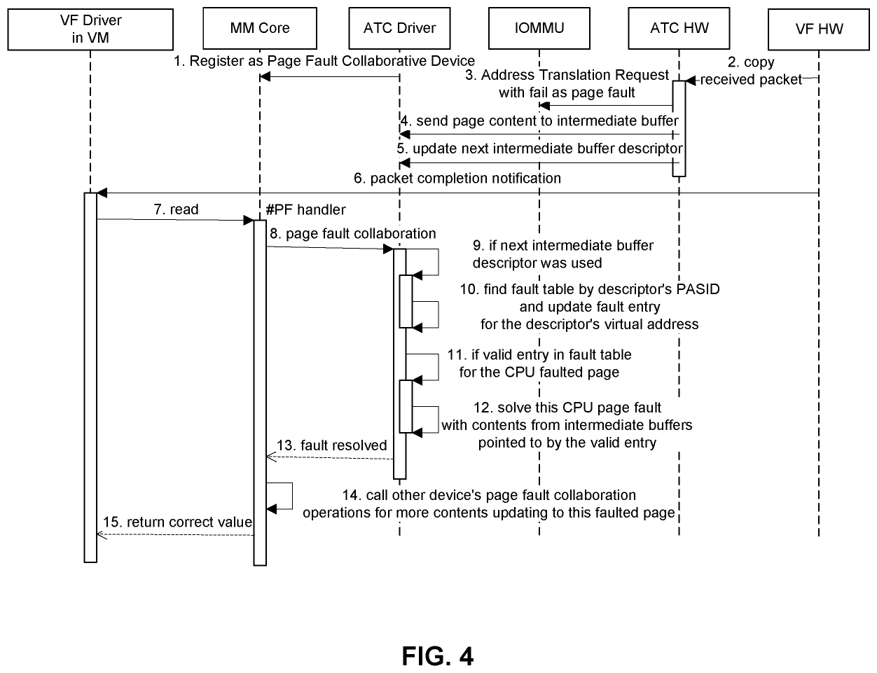

FIG. 4 shows a sequence diagram of a collaborated page fault with device managed host intermediate buffer sequence diagram. At 1, ATC driver registers with MM core as page fault collaborative so that if a page fault occurs, MM core calls ATC driver so that the ATC handles the page fault. At 2, a received packet or data associated with a VF for a device is available for processing. The received packet can be copied to a memory associated with a host virtual address associated with target buffers previously provided by a VF driver. At 3, ATC of the device determines a virtual address to physical translation is not available in page table and a page fault occurs. For example, the ATC can request the IOMMU to provide virtual to physical address translation. However, IOMMU does not identify a virtual to physical address translation and indicates to ATC there is no translation.

At 4, ATC causes a copy of received packet or data to an intermediate buffer. The intermediate buffer can be implemented as a memory device or a memory pool. At 5, the ATC provides ATC driver (executing on host processor) with an updated network intermediate buffer descriptor to identify an intermediate buffer is used to store the received packet. At 6, VF provides a packet completion notification, that a packet was received, to VF driver for the device associated with a VM. The VF driver for the device can receive the packet completion notification before a page fault is resolved.

At 7, the VF driver issues a packet or data read request to MM core to read from a page identified by the buffer identified in packet completion notification. At 8, MM core requests page fault collaboration to ATC driver if collaboration is enabled for the VF associated with the device (VF HW) such as page fault collaboration is enabled for a particular process address space identifier (PASID) and particular virtual address range associated with the read request. Page fault collaboration may not performed for translations not associated with an enabled VF HW, PASID, or virtual address range.

At 9, if a next intermediate buffer descriptor is available and updated (e.g., at 5, next intermediate buffer descriptor is updated), then the process proceeds to 10. Note that the check event queue in operation 9 could utilize Data Plane Development Kit (DPDK) or OpenDataPlane such as checking a queue descriptor for updates not the head or tail register. However, if a next intermediate buffer descriptor is not used or not available, the process proceeds to 11. At 10, page faults can be accumulated into fault table for just a particular process identifier (e.g., PASID) and virtual address. Operation 10 can occur if the operation 9 returns a new event.

At 11, if a valid fault entry is already in fault table, the process can proceed to 12. If a valid fault entry is not in the fault table, then use of the fault table can be bypassed and the page fault can be solved by invoking a page fault handler.

At 12, a page fault for the current fault and other same faults identified in the fault table can be solved by invoking a page fault handler. By use of a fault table, a current page fault can be solved related to collaboration or other faults can be solved that are the same. The address translation can refer to the address of the data in the intermediate buffer or the data can be copied from the intermediate buffer to a destination buffer and the address translation can refer to a physical address of the destination buffer.

At 13, an indication that the fault is resolved can be provided by ATC driver to MM core. At 14, a call can be made to another ATC driver for other devices to resolve the page faults for the same virtual address for those other ATC drivers as well (not shown). At 15, VF driver can access data from received packet from correct physical address based on address translation associated with resolved page fault. Other page faults associated with PASID or virtual addresses not subject to collaborative page fault solving or not in the fault table can be resolved in a user specified order (e.g., first in first out (FIFO)).

For some cases, e.g., Shared Virtual Memory (SVM), an address space may be associated with multiple devices supporting collaborated page fault. Collaboration between devices can involve device I/O page fault handler checking other devices' faults. A timestamp can be associated with data stored in the intermediate buffer, so different devices can update a same faulting page in time stamp order.

The collaborative framework can be used for uses cases including virtual machine (VM) live migration and other cases. Examples can be an extension for Linux® instruction userfaultfd, which already has all the callback registered with MM core.

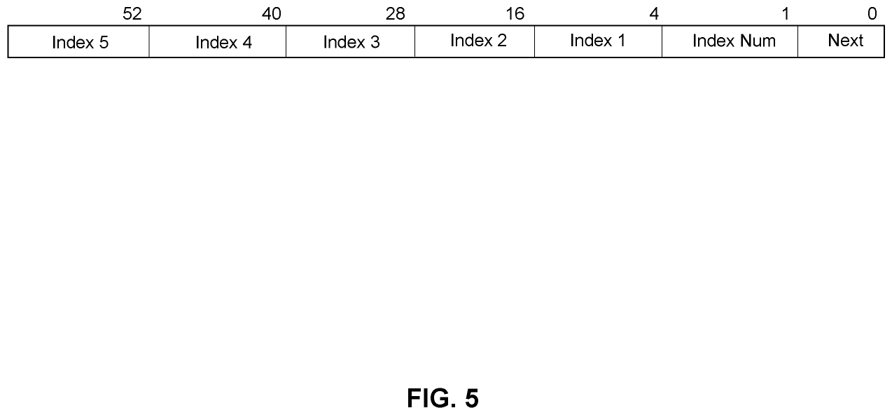

FIG. 5 depicts an example paging entry format in a Page Fault Table. To check whether a faulting page has an associated intermediate buffers in operation (11) of FIG. 4, a page fault table is used for an Address Space (e.g., input output virtual address (IOVA), guest virtual address (GVA), or host virtual address (HVA)) indexed by bus:Device.Function (BDF) and PASID or Domain ID. An ATC driver can create a fault table for a memory address space range and convert use of an ATC intermediate buffer to corresponding entry in fault tables at (10) of FIG. 4.

A fault table entry can include N indexes pointing to intermediate buffer queue entries using values such as queue head and tail register. In some examples, N=5. If the bit 0 “Next” has value 1, the index 5 points to another array of same entry format as an expansion of a current entry and two combined entries can hold 9 indexes. The expanded entry can have another “Next” value 1 to have another expansion entry to continue entry combination.

A background thread could include an interrupt handler triggered by a device or a kernel work threads pre-scheduled by driver. Based on detection of a new intermediate buffer event detected by background thread (e.g., device page fault event handler) or CPU page fault handler, the following operations can be executed. At 1, the address space fault table can be located based on the device BDF, PASID, and/or Domain ID in an event descriptor. At 2, a page fault entry can be retrieved or created in the fault table. At 3, based on current Index Num, Index Num can point to one or more page faults. For example, if Index Num is less than 5, one index inside this entry can point to a new fault event. For example, if Index Num is equal to 5, one new entry from an expansion table is allocated, and previous Index 5 can be the Index 1 in that expansion entry. The value of Index Num in table entry can be 6, and index num value in expansion entry is 1. For example, if Index Num is equal to 6, expansion entry can be updated to be same as fault entry.

At 4, increase device fault event queue scanned index by 1. The updated scanned index can represent a current queue tail and head register, and used by ATC device driver to identify fault table from device fault event. At 5, if ATC device page fault handler thread manages the fault event, ATC device page fault handler thread continues to process page fault. At 6, if CPU page fault thread manages the fault event, CPU page fault thread continues to process the page fault. Various policies can be used to select page fault handling. If throughput is prioritized, pending I/O page fault can be processed, which may cause too much latency for one CPU page fault if may I/O faults are found in one CPU page fault handling duration time. If latency is prioritized, pending I/O page fault in current page's fault table entry can be processed.

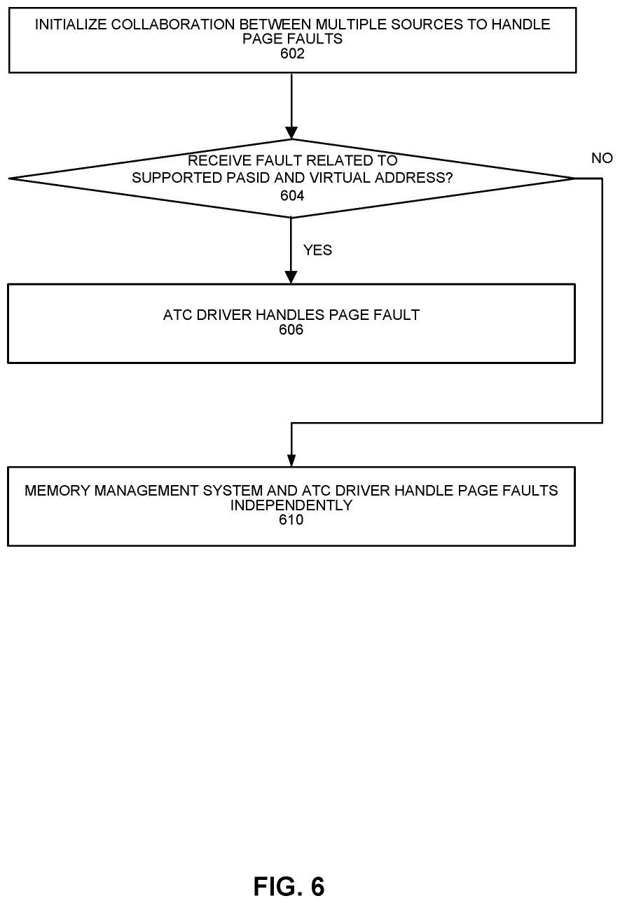

FIG. 6 depicts an example process. The process can be performed in a host system with processors, memory management system, MMU, and/or IOMMU. At 602, configure multiple sources that are able to invoke page fault handling to collaboratively solve a page fault. For example, an ATC driver that handles IOMMU page faults can indicate to a memory management system that handles page faults for a central processing unit that ATC driver is to handle page faults for a particular range of process identifiers, virtual function identifiers, and/or virtual memory address ranges. However, the reverse can be performed where the memory management system indicates to ATC driver that memory management system is to handle page faults for a particular range of process identifiers, virtual function identifiers, and/or virtual memory address ranges.

At 604, based on an indication from a first source of the multiple sources that a page fault occurred for a particular virtual address that is within the particular range of process identifiers, virtual function identifiers, and/or virtual memory address ranges, the process can continue to 606. However, based on an indication from a first source of the multiple sources that a page fault occurred for the particular virtual address that outside of the particular range of process identifiers, virtual function identifiers, and/or virtual memory address ranges, the process can continue to 610.

At 606, a second source of the multiple sources can invoke page fault handling. Page fault handling can include determining a translation of a virtual address provided in connection with a read or write operation to a physical address. Page fault handling can include determining the translation for the particular virtual address as well as other of the same virtual addresses for the same or different process identifiers, virtual function identifiers, and/or virtual memory address ranges that are stored in a fault table. Accordingly, page fault handling can take place for a same virtual address queued in a fault table. In some examples, page fault handling can take place for a same virtual address associated with different devices.

At 610, the multiple sources can invoke page fault handling independently. For example, an ATC driver can request page fault handling for identified page faults and the memory management system can request page fault handling for identified page faults. A race condition identified earlier may result with data read by a VF driver not corresponding to the data in the intermediate buffer.

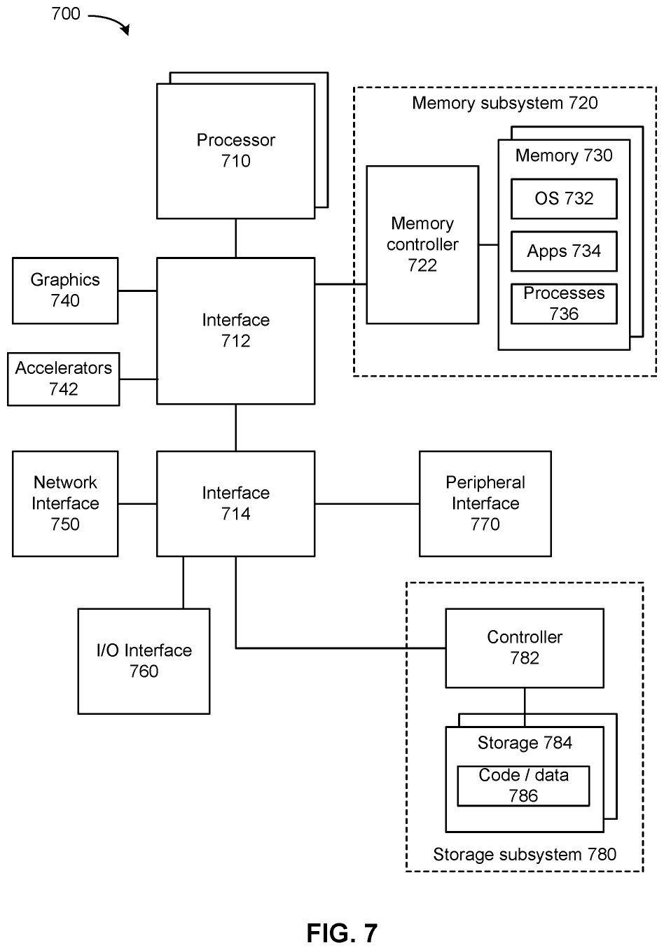

FIG. 7 depicts a system. Components of system 700 (e.g., processor 710, network interface 750, and so forth) to perform a single collaborative page fault handling of address translations, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a display that provides an output to a user. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. OS 732 and driver can execute on a processor sold or designed by Intel®, ARM®, AMD®, Qualcomm®, IBM®, Nvidia®, Broadcom®, Texas Instruments®, among others. Driver and a memory management system can perform a single collaborative page fault handling of address translations, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, network interface 750 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714. Memory 730 can include a memory pool in some examples.

A volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects or communications protocols can be used such as: PCIe (e.g., Peripheral Component Interconnect Express (PCIe) Base Specification 1.0 (2002), as well as earlier versions, later versions, and variations thereof), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL) (e.g., Compute Express Link (CXL) Specification revision 2.0, version 0.7 (2019), as well as earlier versions, later versions, and variations thereof), Universal Chiplet Interconnect Express (UCIe) (e.g., UCIe 1.0 Specification (2022), as well as earlier versions, later versions, and variations thereof), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to memory pools or virtualized storage nodes or accessed using a protocol such as Non-volatile memory express (NVMe) over Fabrics (NVMe-oF) or NVMe. Memory pools and storage nodes can be accessed by connection based on interconnects or communications protocols described herein.

In an example, system 700 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for another. For example, descriptions using the terms “connected” and/or “coupled” may indicate that two or more elements are in direct physical or electrical contact with another. The term “coupled,” however, may also mean that two or more elements are not in direct contact with another, but yet still co-operate or interact with another.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. A component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

Example 1 includes one or more examples, and includes a method comprising: for a selected process identifier and virtual address, solving a page fault arising from multiple sources by a one-time operation.

Example 2 includes one or more examples, wherein the selected process identifier comprises a virtual function (VF) identifier or process address space identifier (PASID).

Example 3 includes one or more examples, wherein the solving a page fault arising from multiple sources by a one-time operation comprises invoking a page fault handler to determine an address translation.

Example 4 includes one or more examples, wherein the multiple sources comprise: an address cache driver and a memory management system.

Example 5 includes one or more examples, wherein the address cache driver performs the solving a page fault arising from multiple sources by invoking a page fault handler.

Example 6 includes one or more examples, wherein the address cache driver manages input output memory management unit (IOMMU) page faults and the memory management system manages central processing unit (CPU) page faults.

Example 7 includes one or more examples, wherein the solving a page fault arising from multiple sources by a one-time operation comprises solving a page fault and one or more other queued page faults for the selected process identifier and the virtual address.

Example 8 includes one or more examples, and includes: for a non-selected process identifier and virtual address, the multiple sources independently solving the page fault.

Example 9 includes one or more examples, and includes a non-transitory computer-readable medium comprising instructions stored thereon, that if executed by one or more processors, cause the one or more processors to: execute a driver that is configured to, for a selected process identifier and virtual address, solve a page fault arising from multiple sources by a one-time operation.

Example 10 includes one or more examples, wherein the selected process identifier comprises a virtual function (VF) identifier or process address space identifier (PASID).

Example 11 includes one or more examples, wherein the solving a page fault arising from multiple sources by a one-time operation comprises invoking a page fault handler to determine an address translation.

Example 12 includes one or more examples, wherein the multiple sources comprise the driver and a memory management system and wherein the driver comprises an address cache driver.

Example 13 includes one or more examples, wherein the address cache driver manages input output memory management unit (IOMMU) page faults and the memory management system manages central processing unit (CPU) page faults.

Example 14 includes one or more examples, wherein the solving a page fault arising from multiple sources by a one-time operation comprises solving a page fault and one or more other queued page faults for the selected process identifier and the virtual address.

Example 15 includes one or more examples, and includes instructions stored thereon that, if executed by one or more processors, cause the one or more processors to: for a non-selected process identifier and virtual address, permit the multiple sources to independently solve the page fault.

Example 16 includes one or more examples, and includes an apparatus comprising: one or more processors and a memory to store instructions that, if executed by the one or more processors, cause the one or more processors to: for a selected process identifier and virtual address, solve a page fault arising from multiple sources by a one-time operation.

Example 17 includes one or more examples, wherein the selected process identifier comprises a virtual function (VF) identifier or process address space identifier (PASID).

Example 18 includes one or more examples, wherein the solve a page fault arising from multiple sources by a one-time operation comprises invoking a page fault handler to determine an address translation.

Example 19 includes one or more examples, wherein the multiple sources comprise: an address cache driver and a memory management system.

Example 20 includes one or more examples, wherein the page fault arises from a read or write operation from a device and wherein the device comprises one or more of: a packet processing device, a network interface device, storage controller, or accelerator.

What is claimed is:

1. A method comprising:
for a selected process identifier and virtual address, solving a page fault arising from multiple sources by a one-time operation.

2. The method of claim 1, wherein the selected process identifier comprises a virtual function (VF) identifier or process address space identifier (PASID).

3. The method of claim 1, wherein the solving a page fault arising from multiple sources by a one-time operation comprises invoking a page fault handler to determine an address translation.

4. The method of claim 1, wherein the multiple sources comprise: an address cache driver and a memory management system.

5. The method of claim 4, wherein the address cache driver performs the solving a page fault arising from multiple sources by invoking a page fault handler.

6. The method of claim 4, wherein the address cache driver manages input output memory management unit (IOMMU) page faults and the memory management system manages central processing unit (CPU) page faults.

7. The method of claim 1, wherein the solving a page fault arising from multiple sources by a one-time operation comprises solving a page fault and one or more other queued page faults for the selected process identifier and the virtual address.

8. The method of claim 1, comprising:
for a non-selected process identifier and virtual address, the multiple sources independently solving the page fault.

9. A non-transitory computer-readable medium comprising instructions stored thereon, that if executed by one or more processors, cause the one or more processors to:
execute a driver that is configured to, for a selected process identifier and virtual address, solve a page fault arising from multiple sources by a one-time operation.

10. The non-transitory computer-readable medium of claim 9, wherein the selected process identifier comprises a virtual function (VF) identifier or process address space identifier (PASID).

11. The non-transitory computer-readable medium of claim 9, wherein the solving a page fault arising from multiple sources by a one-time operation comprises invoking a page fault handler to determine an address translation.

12. The non-transitory computer-readable medium of claim 9, wherein the multiple sources comprise the driver and a memory management system and wherein the driver comprises an address cache driver.

13. The non-transitory computer-readable medium of claim 12, wherein the address cache driver manages input output memory management unit (IOMMU) page faults and the memory management system manages central processing unit (CPU) page faults.

14. The non-transitory computer-readable medium of claim 9, wherein the solving a page fault arising from multiple sources by a one-time operation comprises solving a page fault and one or more other queued page faults for the selected process identifier and the virtual address.

15. The non-transitory computer-readable medium of claim 9, comprising instructions stored thereon that, if executed by one or more processors, cause the one or more processors to:
for a non-selected process identifier and virtual address, permit the multiple sources to independently solve the page fault.

16. An apparatus comprising:
one or more processors and
a memory to store instructions that, if executed by the one or more processors, cause the one or more processors to:
for a selected process identifier and virtual address, solve a page fault arising from multiple sources by a one-time operation.

17. The apparatus of claim 16, wherein the selected process identifier comprises a virtual function (VF) identifier or process address space identifier (PASID).

18. The apparatus of claim 16, wherein the solve a page fault arising from multiple sources by a one-time operation comprises invoking a page fault handler to determine an address translation.

19. The apparatus of claim 16, wherein the multiple sources comprise: an address cache driver and a memory management system.

20. The apparatus of claim 16, wherein the page fault arises from a read or write operation from a device and wherein the device comprises one or more of: a packet processing device, a network interface device, storage controller, or accelerator.
